(19) United States
(12) Patent Application Publication
(10) Pub. No.: US 2011/0122976 A1
(43) Pub. Date: May 26, 2011

(54) METHOD AND SYSTEM FOR DETERMINING WHETHER A TRANSMITTED DATA SIGNAL COMPRISING A CYCLIC PREFIX IS PRESENT IN A RECEIVED SIGNAL

(75) Inventors: Zhongding Lei, Singapore (SG); Po Shin Francois Chin, Singapore (SG)

(73) Assignee: AGENCY FOR SCIENCE, TECHNOLOGY AND RESEARCH, Singapore, SG (SG)

(21) Appl. No.: 12/674,377

(22) PCT Filed: Aug. 6, 2008
(86) PCT No.: PCT/SG08/00291

§ 371 Date: May 12, 2010

Related U.S. Application Data
(60) Provisional application No. 60/957,031, filed on Aug. 21, 2007.

(51) Int. Cl. H04L 27/06

(52) U.S. Cl. 375/340

(57) ABSTRACT

A method for determining whether a transmission signal comprising a cyclic prefix is present in a received signal is described which includes determining a plurality of received signal values from the received signal; forming a plurality of different pairs of the received signal values based on a predefined periodicity of the cyclic prefix; determining a correlation term value for each of the plurality of pairs of the received signal values; and determining whether a data signal is present in the received signal based on a combination of the correlation term values.

### FIELD OF THE INVENTION

Embodiments of the invention generally relate to a method and a system for determining whether a transmitted data signal comprising a cyclic prefix is present in a received signal

### BACKGROUND OF THE INVENTION

With the increasing usage of mobile communications, the electromagnetic spectrum has become a scarce resource. However, recent studies of the Federal Communications Commission (FCC) show that a large portion of the assigned spectrum is only used sporadically. Methods for allowing more efficient use of the electromagnetic spectrum for radio communication purposes are therefore desirable.

### SUMMARY OF THE INVENTION

In one embodiment, a method for determining whether a transmission signal comprising a cyclic prefix is present in a received signal is provided that includes: determining a plurality of received signal values from the received signal; forming a plurality of different pairs of the received signal values based on a predefined periodicity of the cyclic prefix; determining a correlation term value for each of the plurality of pairs of the received signal values, wherein the correlation term value for a pair is determined based on a multiplication of one of the received signal values of the pair with the complex conjugate of the other of the received signal values of the pair; and determining whether a transmission signal is present in the received signal based on a combination of the correlation term values, wherein the combination of the correlation term values takes into account an expected value of a measure of at least one of the received signal values affected by noise.

### SHORT DESCRIPTION OF THE FIGURES

Illustrative embodiments of the invention are explained below with reference to the drawings.

FIG. 1 shows a communication system according to an embodiment.

FIG. 2 shows a transmitter according to an embodiment.

FIG. 3 shows an OFDM symbol structure according to an embodiment.

FIG. 4 shows a flow diagram according to an embodiment.

FIG. 5 shows a circuit according to an embodiment.

FIG. 6 shows a received OFDM symbol according to an embodiment.

FIG. 7 shows a histogram according to one embodiment.

FIG. 8 shows a histogram according to one embodiment.

FIG. 9 shows a graph according to an embodiment.

FIG. 10 shows a graph according to an embodiment.

FIG. 11 shows a graph according to an embodiment.

FIG. 12 shows a graph according to an embodiment.

### DETAILED DESCRIPTION

Cognitive radio is a new paradigm in wireless communications that holds promise for utilizing the electromagnetic spectrum with higher efficiency by means of perceiving the environment, learning behavior and environmental patterns, and appropriately adapting to satisfy the needs of the users, the respective communication network, and the radio environment. Recently, the television broadcast frequency bands have been considered by the FCC (Federal Communications Commission) to be pioneered for Cognitive Radio usage. The IEEE is establishing an international standard, IEEE 802.22 Wireless Regional Area Networks, to utilize the idle spectral bands of Television channels.

The potential interference of Ultra-wideband (UWB) communication to existing or future wideband wireless systems using the same and nearby bands, such as WiMax or 3G/4G cellular networks, have been broadly discussed. The need for detection-and-avoidance (DAA) interference avoidance technologies, enabling the deployment of UWB in Japan, Europe and elsewhere has strongly increased. The industry alliance WiMedia is considering to add DAA as a standard function in wireless interfaces in the near future.

An important task of Cognitive Radio or UWB DAA is that the communication system senses the channel availability or interference level so as to adapt the communication parameters accordingly to retain reliable communications amongst users. The channel sensing is a challenging task since the sensitivity requirement for Cognitive Radio or UWB DAA may be much higher than that for an incumbent receiver and the incumbent signal arriving at the sensing unit may be very weak. It is desirable that the sensing scheme works reliably in a very low signal-to-noise ratio environment.

A popular and the simple approach for signal detection is based on radiometry, i.e. measurement of received energy. However, energy detectors can be highly susceptible to interference or noise uncertainty (i.e. unknown or changing noise level). Communication signals typically have special features that can be exploited for detection. For example, the periodicity or cyclostationarity embedded in sine wave carriers, pulse trains, repeating spreading, or hoping sequences of signals may be used to do cyclostationary detection in some applications. However, cyclostationary detection requires much higher computational load as opposed to energy detection for real-time implementation. In UWB DAA or Cognitive Radio systems, it is desirable to have lower complexity/computational load detection algorithms comparable to the energy detection.

Orthogonal frequency division multiplexing/multiple access (OFDM/OFDMA) is a popular modulation/multiple access scheme in current and presumably in future wireless communication systems, such as WiMax, WiFi, 3GPP LTE, DVB terrestrial digital TV systems, WRAN, etc. In UWB DAA, the major incumbent system concerned is also OFDM/OFDMA based WiMax.

One embodiment relates to the detection of OFDM/OFDMA signals for Cognitive Radio or UWB DAA based on the cyclic Prefix embedded in OFDM(A) signals.

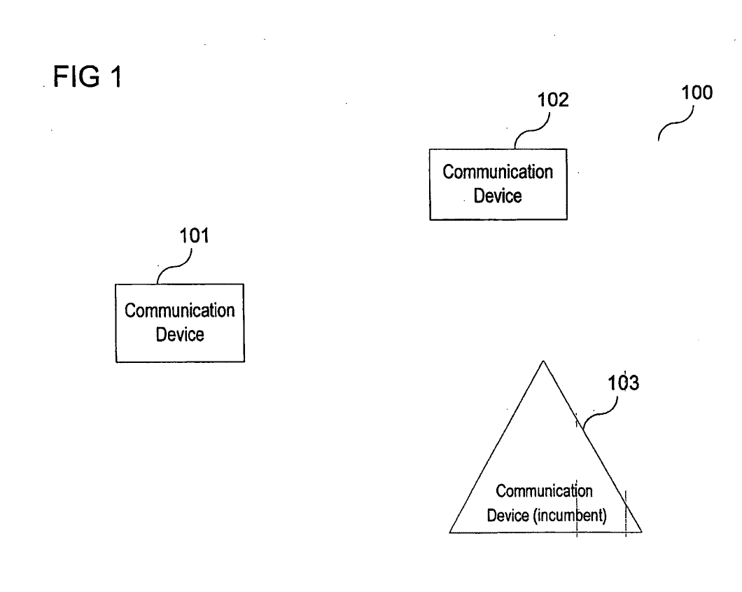

FIG. 1 shows a communication arrangement 100 according to an embodiment.

The communication arrangement includes a first communication device 101, a second communication device 102 and a third communication device 103. It is assumed that the first communication device 101 and the second communication device 102 are part of a first communication system that uses cognitive radio (e.g. an UWB communication system using DAA). In this example, the third communication device 103 has the right to use a certain transmission resource, e.g. a certain frequency band, e.g. due to the fact that the third communication device is part of a second communication system that has licensed the transmission resource (e.g. a communication system according to WiMax using OFDM). The third communication device 103 (sometimes referred to as an incumbent user of the transmission resource) is for example a television transmission station or a base station of a mobile communication system.

The first communication device 101 and the second communication device 102 detect, before using the transmission resource, whether the transmission resource is used by the third communication device 103. Only if the third communication device 103 is not using the transmission resource, the first communication 101 and the second communication device 102 use the transmission resource for communication. In other words, in one embodiment, the first communication device 101 and the second communication device 102 use for example a detection-and-avoidance (DAA) method.

The transmission resource is for example a certain frequency band or a certain set of carrier frequencies. The transmission resource may also be a resource block such as a combinatiqn of one or more carrier frequencies and one or more time intervals.

For example, the first communication system is a Wireless Regional Area Network (WRAN) or a cellular mobile communication system. In one embodiment, the first communication system is for example a communication system according to WiMax, WiFi, 3GPP (Third Generation Partnership Project), e.g. 3GPP LTE (Long Term Evolution).

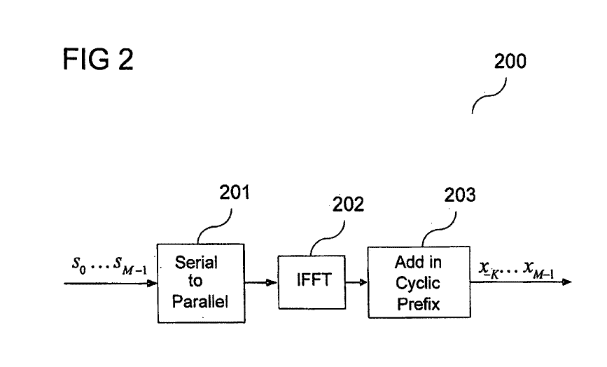

In one embodiment, the third communication device transmits signals according to OFDM(A). The structure of an OFDM(A) transmitter is illustrated in FIG. 2.

FIG. 2 shows a transmitter 200 according to an embodiment.

The transmitter 200 includes a serial-to-parallel circuit 201 that receives a sequence of data symbols s₀Ks_{M-1} as input and maps this sequence to a block (or vector) of data symbols with block size M. The data symbols are for example complex modulation symbols according to QAM (Quadrature Amplitude Modulation) or PSK (Phase Shift Keying). Each data symbol is for example the modulation symbol of one of M sub-carriers. Accordingly, the block of data symbols may be seen as the representation of the signal to be transmitted in the frequency domain.

The transmitter 200 further comprises an IFFT (Inverse Fast Fourier Transform) circuit 202 that receives the block of data of data symbols as input and performs a (discrete) inverse Fourier Transform on the data symbol block. This may be seen as a conversion into the time domain, i.e. as the generation of a representation of the signal to be transmitted in the time domain. The result of the IFFT is accordingly referred to as time domain signal value block while the block of data symbols input into the IFFT circuit is referred to as frequency domain signal value block. Please note that a plurality of sequences of data symbols may be processed analogously to the sequence of data symbols s₀Ks_{M-1}. For example, a stream of data symbols may be grouped into sub-sequences including M data symbols and each sub-sequence is processed as it is described for the sequence s₀Ks_{M-1}.

As an example, the IFFT block size is assumed to be equal to M, i.e. the output of the IFFT circuit 202 is a sequence (assuming a serial output of the IFFT circuit 202) of symbols x₀Kx_{M-1}. In the embodiments described in the following, it is assumed that no over-sampling is used. Embodiments where over-sampling is used may be derived by simple extension from the embodiments described below.

The time domain signal value block generated by the IFFT circuit 202 is appended with a sequence of K<M symbols to the beginning of the time domain signal value block by a cyclic prefix circuit 203 resulting in a sequence of symbols x_{-K}Kx_{M-1} (in the time domain). This is illustrated in FIG. 2.

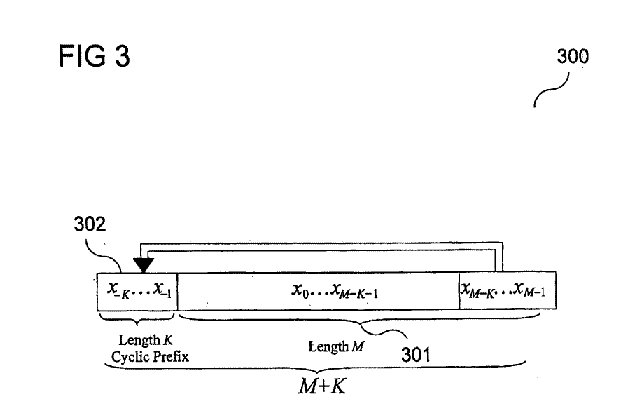

FIG. 3 shows an OFDM symbol structure 300 according to an embodiment.

The sequence of symbols x₀Kx_{M-1} is herein referred to as a useful OFDM symbol 301 (of length M). The sequence of symbols x_{-Kx}_{M-1} is herein referred to as an OFDM symbol 300 (of length M+K).

The useful OFDM symbol 301 is extended by a cyclic prefix 302 at the beginning of the useful OFDM symbol 301, i.e. the cyclic prefix 302 is transmitted before the useful OFDM symbol 301. This means the OFDM symbol 300 is the useful OFDM symbol 301 together with the cyclic prefix 302. The useful OFDM symbol 301 also referred to as an (OFDM) useful transmission symbol. The OFDM symbol 300 is also referred to as an (OFDM) transmission symbol.

The sequence of time domain signal values x_{-KKx}₋₁ forming the cyclic prefix 302 is a copy of the last K symbols x_{M-K}Kx_{M-1} of the useful OFDM symbol 301, i.e., x_{d}=x_{M+d} in case that the (negative integer) index d is in the interval [−K, −1].

The relationship between the frequency domain signal value block (input to IFFT circuit 202) and the time domain signal value block (output of IFFT circuit 202) is given by

$${x}_{d} = 1 / \sqrt{M} \cdot {\sum }_{m = 0}^{M - 1} {s}_{m} \cdot {e}^{j 2 π ( d - K ) m / M} \qquad ( 1 )$$

for d=0, . . . , M−1.

The time domain signal according to the sequence X_{d} (d=−K, . . . , M−1) is pulse shaped before transmission. After passing through a frequency selective fading channel, the signal received at a receiver (for example the first communication device 101 or the second communication device 102 sensing whether the third communication device 103 is transmitting data) can be written as

$${r}_{d} = {\hat{r}}_{d} + {n}_{d} = {\sum }_{i = 0}^{L - 1} {x}_{d - i} \cdot {h}_{i} + {n}_{d} \qquad ( 2 )$$

where the h₁ (i=0, L−1) reflect the transmission characteristics of the composite channel with channel length L, taking into consideration the effect of pulse shaping. Here, a slow fading channel which does not change from symbol to symbol during an observation window is assumed. The noise-free received signal values, i.e. the signal values as which the x_{d} (d=−K, . . . , M−1) are received after their transmission (and being affected by the channel), are denoted as \hat{r}_{d} (d=−K, . . . , M−1). The contaminating noise is assumed to be additive Gaussian white noise (AWGN) with zero mean and variance σₘ² and is modeled by the n_{d} (d=−K, . . . , M−1).

As mentioned above, the first communication device 101 and the second communication device 102 detect whether the third communication device 103 is transmitting data before using the transmission resources that may only be used when the third communication device is not using them (e.g. due to licensing). The detecting communication device receives a signal on the transmission resource for which it performs this detection (for example for a certain frequency band) and determines whether this signal holds a data signal transmitted by the third communication device 103. This detection problem can be formulated as a binary hypothesis testing problem:

H₀:r_{d}=n_{d} (3)

H₁:r_{d}=\hat{r}_{d}+n_{d}

The hypothesis H₀ means that a received signal value only includes noise (signal absent) and the hypothesis H₁ means that the received signal value includes the noise free received signal value \hat{r}_{d} and noise (signal present, i.e. in this case \hat{r}_{d} given as in equation (2)).

In one embodiment, the communication device carrying out the detection determines which of the two hypotheses is true using a sequence of observations (i.e. a sequence of received signal values) r_{d} for d=1,2 KW with the observation window length W. Hypotheses H₀ and H₁ assume the signal is absent and present, respectively.

Energy detection may be carried out based on the hypotheses as in formulation (3). However, since energy detection typically does not exploit features of the signal to be detected and the signal power to noise power is of importance for the energy detection, the reliability of energy detection typically suffers from interference or noise uncertainty.

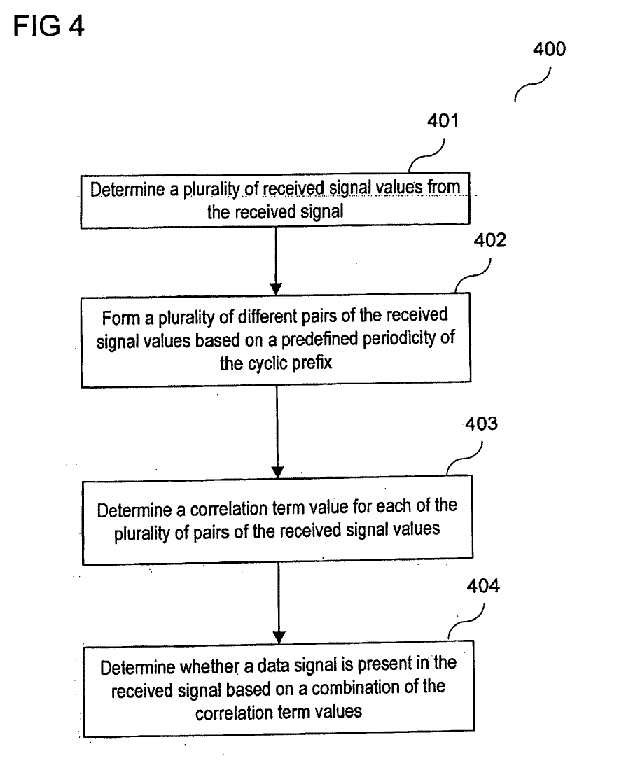

In one embodiment a method for determining whether a transmission signal (e.g. a transmitted data signal) comprising a cyclic prefix is present in a received signal is used as it is shown in FIG. 4. The method is for example used by the first communication device 101 or the second communication device 102 to detect whether the third communication device 103 is transmitting a data signal.

FIG. 4 shows a flow diagram 400 according to an embodiment.

In 401, a plurality of received signal values are determined from the received signal.

In 402, a plurality of different pairs of the received signal values are formed based on a predefined periodicity of the cyclic prefix.

In 403, a correlation term value is determined for each of the plurality of pairs of the received signal values, wherein the correlation term value for a pair is determined based on a multiplication of one of the received signal values of the pair with the complex conjugate of the other of the received signal values of the pair.

In 404, it is determined whether a transmission signal is present in the received signal based on a combination of the correlation term values, wherein the combination of the correlation term values takes into account an expected value of a measure of at least one of the received signal values affected by noise.

For example, the combination of the correlation term values takes into account an expected value of a measure of at least one of the received signal values of each pair of received signal values affected by noise. In one embodiment, the determination of each correlation term value takes into account an expected value of a measure of at least one of the received signal values of the pair affected by noise such that the combination of the correlation term values takes into account an expected value of a measure of at least one of the received signal values of each pair of received signal values affected by noise.

In one embodiment, the transmission signal comprises a plurality of transmission symbols, wherein each transmission symbol comprises a useful transmission symbol prepended with a cyclic prefix.

Each useful transmission symbol for example corresponds to a plurality of data symbols.

The cyclic prefix of a transmission symbol for example corresponds to a part of the data symbols of the useful transmission symbol. For example, the cyclic prefix of a transmission symbol corresponds to a number of the last (according to their order of transmission) data symbols of the useful transmission symbol.

The predefined periodicity is for example the number of data symbols to which each useful transmission symbol corresponds.

In one embodiment, each pair of received signal values is formed such that between one of the received signal values of the pair and the other of the received signal values of the pair there is a number of received signal values according to the periodicity.

In one embodiment, the predefined periodicity is the transmission time of a useful transmission symbol. Each pair of received signal values is for example formed such that the transmission time of the received signal values of the pair differs by the predefined periodicity.

For example, the transmission signal is an OFDM signal comprising a plurality of (useful) OFDM symbols, wherein each (useful) OFDM symbol corresponds to a sequence of data symbols in the time domain and wherein each useful OFDM symbol is prepended with a cyclic prefix. The received values are for example determined as the received data symbols of the sequence of symbols in the time domain.

In one embodiment, the combination of the correlation term values is based on a sum of the correlation term values, e.g.

divided by the expected value of a measure of at least one of the signal values.

For example, the expected value of a measure of at least one of the signal values is the expected value of a norm of one of the signal values affected by noise.

In one embodiment, the noise is the noise that is expected to affect the data signal in course of the reception (and/or affecting the transmission).

The determination whether a transmission signal is present in the received signal for example comprises the calculation of a decision value from the combination of the correlation term values and wherein it is determined whether a transmission signal is present in the received signal based on whether the decision value is below or above a predefined threshold.

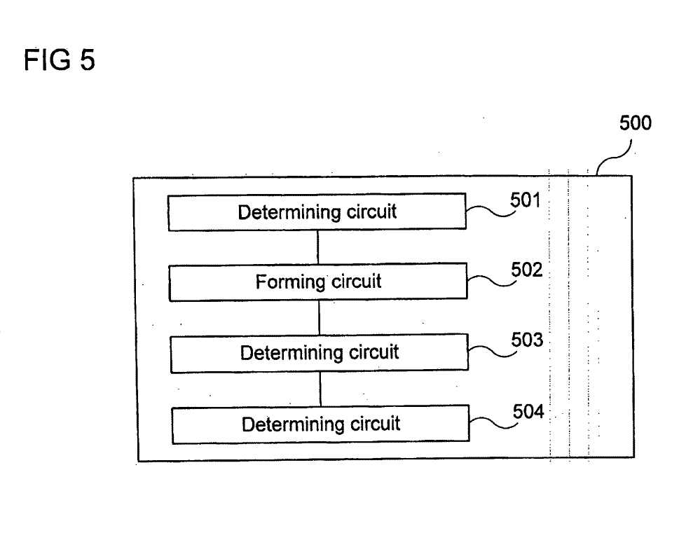

The method illustrated in FIG. 4 is for example carried out by a circuit as illustrated in FIG. 5.

FIG. 5 shows a circuit 500 according to an embodiment.

The circuit 500 includes a first determining circuit 501 configured to determine a plurality of received signal values from the received signal.

Further, the circuit 500 includes a first forming circuit 502 configured to form a plurality of different pairs of the received signal values based on a predefined periodicity of the cyclic prefix.

A second determining circuit 503 of the circuit 500 is configured to determine a correlation term value for each of the plurality of pairs of the received signal values, wherein the correlation term value for a pair is determined based on a multiplication of one of the received signal values of the pair with the complex conjugate of the other of the received signal values of the pair.

The circuit 500 further includes a third determining circuit 504 which is configured to determine whether a transmission signal is present in the received signal based on a combination of the correlation term values, wherein the combination of the correlation term values takes into account an expected value of a measure of at least one of the received signal values affected by noise.

In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be software being implemented or executed by a processor, e.g. any kind of computer program, e.g. a computer program using a virtual machine code such as e.g. Java. Any other kind of implementation of the respective functions which will be described in more detail below may also be understood as a “circuit” in accordance with an alternative embodiment.

A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

Illustratively, in one embodiment, the fact is used that the signal for which it is to be detected whether it is present in the received signal (or, for example, the received signal only comprises noise) has a cyclic prefix, for example as it may be used in data transmission according to OFDM. By forming pairs of received signal values according to the periodicity of the cyclic prefix, the fact may be used for detection that the correlation between the cyclic prefix and the data symbols in the transmitted signal that the cyclic prefix corresponds to (e.g. is a copy of) is high. This means that if the pairs are formed according to the cyclic prefix periodicity of the transmitted signal, a high correlation of the received signal values in a pair may be expected (e.g. the received signal values have a similar phase) if the transmitted signal is present.

The correlation term value is for example determined for the pair of received signal values, which are, for example, complex numbers, by a projection of one of the received signal values onto the other received signal value. This is for example achieved by a multiplication of one of the received signal values with the complex conjugate of the other of the received signal values in the case of complex numbers.

The decision whether the transmitted signal is present in the received signal is for example carried out based on the combination of correlation term values by comparing the combination of correlation term values (e.g. a (weighted) sum of the correlation term values, for example referred to as a correlation value) with a threshold value, which is for example predetermined based on the probability distribution functions of the combination of the correlation term values under the hypotheses that the transmitted signal is present in the received signal or not. For example, a likelihood ratio test (LRT) is designed and used for the decision. An optimal test (according to some criterion, e.g. the optimal LRT test) may be used or a sub-optimal test may be used.

The transmitted signal, the presence of which is to be detected, is for example (if it is transmitted) transmitted via a frequency selective fading channel.

In one embodiment, the method illustrated in FIG. 4 is used to detect whether a communication device, for example the third communication device 103 in FIG. 1, is transmitting OFDM signals that have cyclic prefix. This means that in one embodiment, the special feature of OFDM signals having a cyclic prefix is exploited for signal detection. The detection of OFDM signals is in this embodiment based on the cyclic prefix, i.e. makes use of the usage of a cyclic prefix.

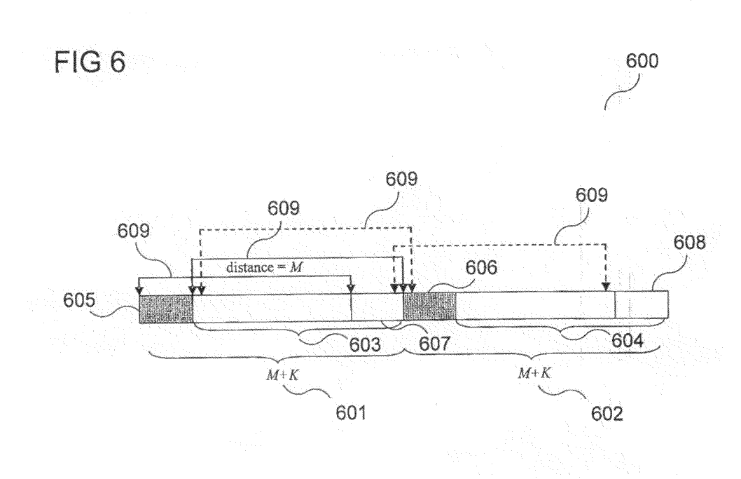

An example of a structure of an OFDM signal received at a detecting device, e.g. the first communication device 101 or the second communication device 103 in the communication arrangement 100 of FIG. 1 is illustrated FIG. 6. It is noted that in this embodiment the channel is assumed to be a single path fading channel for easy illustration.

FIG. 6 shows a received OFDM symbol 600 assuming a single path fading channel according to an embodiment. It is noted that the received OFDM symbol in a multiple fading channel will be a superposition of multiple delayed copies of a transmitted OFDM symbol. Detection methods according to embodiments may also be applied in case of a multipath environment, i.e. in case that transmitted signals are affected by multipath fading.

A first received OFDM symbol 601 and a second received OFDM symbol 602 are shown.

The first OFDM symbol 601 includes a first useful OFDM symbol 603 of length M and a first cyclic prefix 605 of length K. The first cyclic prefix 605 corresponds to the last K symbols of the first OFDM symbol 603. These last K symbols are referred to as a first tail section 607 of the first OFDM symbol 603.

The second OFDM symbol 602 includes a second useful OFDM symbol 604 of length M and a second cyclic prefix 606 of length K. The second cyclic prefix 606 corresponds to the last K symbols of the second useful OFDM symbol 604. These last K symbols are referred to as a second tail section 608 of the second OFDM symbol 604.

As can be seen, the cyclic prefix 605, 606 occurs with a periodicity of M, i.e. the length of the useful OFDM symbols 603, 604.

Arrows 609 each indicate a pair of signal values (e.g. data symbols) which have a distance of M symbols. In other words, the arrows 609 each indicate two samples of the received signal with sampling time distance of one useful OFDM symbol duration (i.e. the symbol duration before adding cyclic prefix).

In one embodiment, the fact that the transmitted cyclic prefix 605, 606 corresponds to the respective tail section 607, 608, or, in other words, is a copy of the part of the signal with sampling time distance M to the cyclic prefix is used for the detection.

For example, the following hypotheses are examined for the detection (this may be seen as an alternative to the examination of the hypotheses according to (3)):

$$\begin{matrix}{H}_{0} \text{:} ζ = {\sum }_{d} {z}_{d} \\ = {\sum }_{d} {n}_{d} \cdot {n}_{M + d}^{*} / E [ {\vert {r}_{d} \vert}^{2} ]\end{matrix} \\ \begin{matrix}{H}_{1} \text{:} ζ = {\sum }_{d} {z}_{d} \\ = {\sum }_{d} ( {\hat{r}}_{d} + {n}_{d} ) \cdot ( {\hat{r}}_{M + d}^{*} + {n}_{M + d}^{*} ) / E [ {\vert {\hat{r}}_{d} + {n}_{d} \vert}^{2} ]\end{matrix} \qquad ( 4 )$$

where z_{d}=r_{d}·r_{M+d}*/E[|r_{d}|²], ‘*’ stands for the Hermitian operation (transposition and complex conjugation), and the summation is over the observation window of length W (i.e. d=1.2 KW), which is for example a single continuous value range (i.e.

corresponds to a single continuous time interval) or includes multiple discontinuous sub-windows.

This means that the value is calculated from the received signal values based on a summation of the z_{d} over the observation window, i.e. for d=1.2 KW. Each z_{d} is a measure of the correlation between two samples with distance M in the received signal with received signal values r_{d} as given in (2). This means that each z_{d} is calculated from a pair of received signal values, wherein the signal values that are part of the pair are selected according to the periodicity of the cyclic prefix.

The value ζ may be seen as an aggregate correlation value formed of the z_{d}, which may be seen as correlation term values. According to the model of the transmission, the value of ζ should be equal to

$${\sum }_{d} {n}_{d} \cdot {n}_{M + d}^{*} / E [ {\vert {r}_{d} \vert}^{2} ]$$

if there is no data signal present (hypothesis H₀) and equal to

$${\sum }_{d} ( {\hat{r}}_{d} + {n}_{d} ) \cdot ( {\hat{r}}_{M + d}^{*} + {n}_{M + d}^{*} ) / E [ {\vert {\hat{r}}_{d} + {n}_{d} \vert}^{2} ]$$

if there is a data signal present in the received signal (hypothesis H₁).

It may intuitively be expected that the correlation as given by the value ζ is at its peak when an OFDM signal having a cyclic prefix (with the periodicity on which the forming of the pairs of received signal values is based) is present in the received signal.

On the other hand, if the received signal only contains noise or a signal without cyclic prefix the paired signal values may be expected to be uncorrelated and there should be only minor, if any, correlation between the paired signal values (samples).

Accordingly, based on the value ζ, it may be determined whether in the received signal an OFDM signal is present or whether only noise or other signals (without a cyclic prefix with the expected periodicity) are present.

In one embodiment, for the derivation of a likelihood ratio test (LRT) for the hypotheses according to (4), a probability distribution function (PDF) of the value ζ under each hypothesis is determined.

A) PDF of ζ under H₀

Under the hypotheses H₀, ζ may be seen as the sum of the products of two normal distributed variables. The distribution of the products of two normal distributed variables, i.e., z_{d}Δr_{d}·r_{\dot{M}+d} is the complex Normal Product Distribution. It has two parameters, one being a delta function and the other being a modified Bessel function of the second kind. The distribution of the sums of the products is more complex but may be approximated. In this context here, an approximation based on central limit theory may be used.

In the context of signal detection for DAA or cognitive radio systems, the detection time required is usually at the level of hundreds of milliseconds_{:} This corresponds to an observation window with thousands to hundreds of thousands samples. Based on central limit theory, ζ can be assumed to be a Gaussian distributed random process. Referring to (4), the mean and variance of ζ under hypothesis H₀ can be computed as

$$\begin{matrix}{m}_{0} {Δ}_{\underline{\_}} E [ ζ \vert {H}_{0} ] = {\sum }_{d} E [ {n}_{d} \cdot {n}_{M + d}^{*} ] / {σ}_{n}^{2} = 0 & ( 5 ) \\ \begin{matrix}{σ}_{0}^{2} {Δ}_{\underline{\_}} E [ {\vert ζ \vert}^{2} \vert {H}_{0} ] = {\sum }_{{d}_{1}} {\sum }_{{d}_{2}} E [ ( {n}_{{d}_{1}} \cdot {n}_{M + {d}_{1}}^{*} ) ( {n}_{{d}_{2}}^{*} \cdot {n}_{M + {d}_{2}} ) ] / {σ}_{n}^{4} \\ = {\sum }_{d} E [ {\vert {n}_{d} \vert}^{2} ] \cdot E [ {\vert {n}_{M + d} \vert}^{2} ] / {σ}_{n}^{4} \\ = W\end{matrix} & ( 6 )\end{matrix}$$

The third equation in (6) is satisfied since different noise samples are uncorrelated.

B) PDF of ζ under H₁

Referring to (4), it can be seen that the exact PDF of C under H₁ is more complex than that under H₀. However, an approximation by using Gaussian distribution may be used as is shown in the following.

The signal values in the frequency domain (e.g. modulation symbols according to QPSK, i.e. quadrature phase shift keying, or QAM, i.e. quadrature amplitude modulation) sₘ (m=0 . . . M−1) may be assumed to form an independent identical uniformly distributed random process with mean and autocorrelation function given by

$$E [ {s}_{m} ] = 0 \\ E [ {s}_{m} \cdot {s}_{n}^{*} ] = \{ \begin{matrix}E [ {\vert {s}_{m} \vert}^{2} ] {Δ}_{\underline{\_}} {σ}_{s}^{2} & ( m = n ) \\ E [ {s}_{m} ] \cdot E [ {s}_{n}^{*} ] = 0 & ( m \neq n )\end{matrix} \qquad ( 7 )$$

where σₛ² is the variance of the frequency domain signal.

After FFT according to equation (1), the signal values in the time domain x_{d} can be approximated by a Gaussian distributed random process when M is large according to central limit theory. M is for example 256 in OFDM mode and 2048/1024/512 in OFDMA mode in IEEE 802.16 or WiMax and up to 8096 in DVB-T systems and is thus in these cases large enough for this approximation.

Based on (2), it may still be assumed that the received signal r_{d} is Gaussian distributed for a given realization of the fading channel. Similar to the assumption made under hypothesis H₀, ζ in (4) can be approximated by a Gaussian distributed random process.

It should be noted, however, that the derivation of mean m₁=E[ζ|H₁] and variance σ₁²=E[|ζ|²|H₁]−m₁² of ζ under hypothesis H₁ is non-trivial due to the complex format of ζ under H₁ and the cross correlations amongst the terms once (4) is expanded. It involves computation of fourth moments of complex variables.

The mean and variance are given by

$$\begin{matrix}\begin{matrix}{m}_{1} = E [ ζ \vert {H}_{1} ] \\ = α W \cdot {σ}_{\hat{r}}^{2} / ( {σ}_{\hat{r}}^{2} + {σ}_{n}^{2} ) \\ = α W \cdot SNR / ( SNR + 1 )\end{matrix} & ( 8 ) \\ \begin{matrix}{σ}_{1}^{2} = E [ {\vert ζ \vert}^{2} \vert {H}_{1} ] - {m}_{1}^{2} \\ = W \cdot [ 1 + 2 {α}^{2} {σ}_{\hat{r}}^{4} / {( {σ}_{\hat{r}}^{2} + {σ}_{n}^{2} )}^{2} ] \\ = W \cdot [ 1 + 2 {α}^{2} \cdot {SNR}^{2} / {( SNR + 1 )}^{2} ]\end{matrix} & ( 9 )\end{matrix}$$

where

$$\begin{matrix}{σ}_{\hat{r}}^{2} = E [ {\hat{r}}_{d} \cdot {\hat{r}}_{d}^{*} ] \\ = E [ ( {\sum }_{i = 0}^{L - 1} {x}_{d - i} \cdot {h}_{i} ) \cdot ( {\sum }_{j = 0}^{L - 1} {x}_{d - j}^{*} \cdot {h}_{j}^{*} ) ] \\ = {\sum }_{i = 0}^{L - 1} {\vert {h}_{i} \vert}^{2} E [ {\vert {x}_{d - i} \vert}^{2} ] \\ = {\sum }_{i = 0}^{L - 1} {\vert {h}_{i} \vert}^{2} \cdot {σ}_{s}^{2} .\end{matrix} \qquad ( 10 )$$

is the received signal power at the detection device, SNR=σ_{\dot{r}}²/σₙ² is the. received signal-to-noise ratio, and α=K/(M+K) is the ratio of the cyclic prefix duration over one OFDM symbol (including cyclic prefix) duration. Details of the derivation of (8) and (9) are given below. It may be verified that (6) can be treated as a special case of (9) when the signal power is zero.

With the PDFs of ζ under hypotheses H₀ and H₁ as derived in above, a likelihood ratio test (LRT) for OFDM signal detection may be derived. The LRT of the statistics ζ in logarithmic scale can be written as

$$Λ = ln \frac{{p}_{ζ \vert {H}_{1}} ( ζ \vert {H}_{1} )}{{p}_{ζ \vert {H}_{0}} ( ζ \vert {H}_{0} )} = ln \frac{\frac{1}{\sqrt{2 π} {σ}_{1}} exp ( - \frac{( ζ - {m}_{1} ) {( ζ - {m}_{1} )}^{H}}{2 {σ}_{1}^{2}} )}{\frac{1}{\sqrt{2 π} {σ}_{0}} exp ( - \frac{{ζζ}^{H}}{2 {σ}_{0}^{2}} )} \qquad ( 11 )$$

After canceling common terms, one has

$$Λ = \frac{{\vert ζ \vert}^{2}}{2 {σ}_{0}^{2}} - \frac{{\vert ζ - {m}_{1} \vert}^{2}}{2 {σ}_{1}^{2}} + ln \frac{{σ}_{0}}{{σ}_{1}} . \qquad ( 12 )$$

Based on (12), the optimal LRT is

$$Λ = \frac{{\vert ζ \vert}^{2}}{2 {σ}_{0}^{2}} - \frac{{\vert ζ - {m}_{1} \vert}^{2}}{2 {σ}_{1}^{2}} + ln \frac{{σ}_{0}}{{σ}_{1}} \begin{matrix}{>}^{{H}_{1}} \\ {<}_{{H}_{0}}\end{matrix} ln η \qquad ( 13 )$$

where η is the threshold of the LRT. Since m₁ is real and σ₁²>σ₀², (13) may be rewritten in an equivalent format as

$$\begin{matrix}f ( Λ ) \begin{matrix}{>}^{{H}_{1}} \\ {<}_{{H}_{0}}\end{matrix} {η}^{′} \\ where & ( 14 ) \\ f ( Λ ) = {\vert ζ + c \vert}^{2} & ( 15 ) \\ c = \frac{{m}_{1}}{{σ}_{1}^{2} / {σ}_{0}^{2} - 1} = ( W / 2 α ) \cdot ( 1 + 1 / SNR ) & ( 16 )\end{matrix}$$

and the corresponding threshold is

$${η}^{′} = [ \frac{{σ}_{1}^{2} ln ( {η}^{2} \cdot {σ}_{1}^{2} / {σ}_{0}^{2} )}{{m}_{1}} + {m}_{1} ] \cdot c + {c}^{2} . \qquad ( 17 )$$

In one embodiment, to do OFDM signal detection according to the LRT, f(Λ) is computed according to (15) using the samples (received signal values) observed in the observation window with length W. Then the computed f(Λ) is compared with a predetermined threshold value η′. If f(Λ) is larger than η′, it is decided that an OFDM signal is present in the received signal. Otherwise, it is decided that there is no OFDM signal present in the received signal (or there is no OFDM signal present with the predefined periodicity M).

In one embodiment, the threshold value η is set according to the required false alarm rate (FAR), for example following the Neyman-Pearson Criterion, instead of using (17) for setting the threshold.

In the following, the theoretical probability of detection (PD) and false error rate (FAR) are derived for the LRT according to (14). For this, the distribution of the test statistics f(η) under hypotheses H₀ and H₁ is used.

Above, it was derived that ζ is a Gaussian random variable under both hypothesis H₀ and hypothesis H₁. The square of a sum of a real Gaussian variable and a real scalar follows a non-central chi-square distribution. However, it is not clear whether it is still the case for a complex Gaussian variable, as f(Λ) in (15). Since this is not straightforward and nontrivial, the distribution of f(Λ) is derived first as follows.

The complex random variable ζ is defined as the sum of two independent real random variables a and b, i.e., ζ=a+j·b.

Thus, with (15),

f(Λ)|a+jb+c|²=(a+c)²+b² (18)

where

$$( a + c ) ∼ N ( {m}_{a} + c , \frac{{σ}_{ζ}^{2}}{2} ) , b ∼ N ( {m}_{b} , \frac{{σ}_{ζ}^{2}}{2} ) ,$$

σ_{ζ}² is the variance of ζ, and mₐand m_{b} are the means of a and b respectively. The random variable

$${( a + c )}^{2} / \frac{{σ}_{ζ}^{2}}{2}$$

is non-central chi-square distributed with one degree of freedom and non-centrality parameter

λₐ=2(mₐ+c)²/σ_{ζ}² (19)

### Similarly,

$$b / \frac{{σ}_{ζ}^{2}}{2}$$

is non-central chi-square distributed with one degree of freedom and non-centrality parameter

λ_{b}=2m_{b}²/σ_{ζ}² (20)

To obtain the distribution of f(Λ), the following Proposition is used.

Proposition 1: A sum of independent random variables R₁,r₂Kr_{N} with non-central chi-square distribution is still a non-central chi-square distributed variable with

$${\sum }_{i = 1}^{N} {k}_{i}$$

degree of freedom and non-centrality parameter

$${\sum }_{i = 1}^{N} {λ}_{i} ,$$

where k₁ and λ₁ are the degree of freedom and non-centrality parameter for r₁, i=1K N.

The proof of Proposition 1 is given below. Based on Proposition 1, it may be concluded that the distribution of

$$f ( Λ ) / \frac{{σ}_{ζ}^{2}}{2} = [ {( a + c )}^{2} + {b}^{2} ] / \frac{{σ}_{ζ}^{2}}{2}$$

is non-central chi-square distributed with two degrees of freedom and non-centrality parameter

λ=λₐ+λ_{b}=2((mₐ+c)²+m_{b}²)/σ_{λ}² (21)

The cumulative distribution function (CDF) of

$$f ( Λ ) / \frac{{σ}_{ζ}^{2}}{2}$$

with k=2 degrees of freedom and non-centrality parameter λ is

$$P ( x ; 2 , λ ) = {\sum }_{i = 0}^{∞} {e}^{- λ / 2} \frac{{( λ / 2 )}^{i}}{i !} Q ( x ; 2 + 2 i ) \qquad ( 22 )$$

where Q(x;k) is the CDF of the central chi-squared distribution given by

$$Q ( x ; k ) = \frac{γ ( k / 2 , x / 2 )}{Γ ( k / 2 )} , \qquad ( 23 )$$

Γ(k)=∫₀^{∞}t^{k-1}e⁻¹dt is the gamma function, and γ(k,x)=∫₀^{x}t^{k-1}e⁻¹dt is the incomplete Gamma function.

Under hypothesis H₀, ζ has zero mean with variance σ₀², which implies mₐ=m_{b}=0 and σ_{ζ}²=σ₀²=W. Substituting this in (21) the non-centrality parameter under hypothesis H₀ is obtained as

λ₀=2c²/σ₀²=(W/2α²)(1+1/SNR)². (24)

Under hypothesis H₁, the mean is m₁ or mₐ=m₁=α·σ_{ė}² and m_{b}=0, and the variance is σ_{ζ}²=σ₁²=W·[1+2α²·SNR²/(SNR+1)²]. Substituting this in (21) gives the non-centrality parameter under hypothesis H₁ as

λ₁=2(m₁+c)²/σ₁²=W+λ₀ (25)

Replacing λ in (22) with λ₀ in (24) and λ₁ in (25) respectively, the CDFs of

$$f ( Λ ) / \frac{{σ}_{ζ}^{2}}{2} ,$$

under hypotheses H₀ and H₁, are obtained as

$$\begin{matrix}P ( x ; 2 , {λ}_{0} \vert {H}_{0} ) = {\sum }_{i = 0}^{∞} {e}^{- ( W / 4 {α}^{2} ) {( 1 + 1 / SNR )}^{2}} \cdot \frac{( W / 4 {α}^{2} ) {( 1 + 1 / SNR )}^{2 i}}{i !} Q ( x ; 2 + 2 i ) & ( 26 ) \\ P ( x ; 2 , {λ}_{1} \vert {H}_{1} ) = {\sum }_{i = 0}^{∞} {e}^{- W / 2} \cdot {e}^{- ( W / 4 {α}^{2} ) {( 1 + 1 / SNR )}^{2}} \cdot \frac{{[ W / 2 + ( W / 4 {α}^{2} ) {( 1 + 1 / SNR )}^{2} ]}^{i}}{i !} \cdot Q ( x ; 2 + 2 i ) & ( 27 )\end{matrix}$$

With (26) and (27), the FAR and PD of the LRT according to (14) may be calculated.

Under H₀, the false alarm probability is

$$\begin{matrix}{P}_{FA} = P ( Λ > ln η \vert {H}_{0} ) \\ = P ( f ( Λ ) / \frac{{σ}_{0}^{2}}{2} > {η}^{′} / \frac{{σ}_{0}^{2}}{2} \vert {H}_{0} ) \\ = 1 - P ( {η}^{′} / \frac{{σ}_{0}^{2}}{2} ; 2 , {λ}_{0} \vert {H}_{0} )\end{matrix} \qquad ( 28 )$$

where

$$P ( {η}^{′} / \frac{{σ}_{0}^{2}}{2} ; 2 , {λ}_{0} \vert {H}_{0} )$$

is the result of substituting x with

$${η}^{′} / \frac{{σ}_{0}^{2}}{2}$$

in (26) .

Similarly, under H₁, the probability of detection is

$$\begin{matrix}{P}_{D} = P ( Λ > ln η \vert {H}_{1} ) \\ = P ( f ( Λ ) / \frac{{σ}_{1}^{2}}{2} > {η}^{′} / \frac{{σ}_{1}^{2}}{2} \vert {H}_{1} ) \\ = 1 - P ( {η}^{′} / \frac{{σ}_{1}^{2}}{2} ; 2 , {λ}_{1} \vert {H}_{1} )\end{matrix} \qquad ( 29 )$$

where

$$P ( {η}^{′} / \frac{{σ}_{1}^{2}}{2} ; 2 , {λ}_{1} \vert {H}_{1} )$$

is the result of substituting x with

$${η}^{′} / \frac{{σ}_{1}^{2}}{2}$$

in (27).

It should be noted that under Neyman-Pearson Criterion in practice, (28) can be used to compute the theoretical threshold η′ of the optimal LRT (14) for a given FAR. In fact, the threshold η′ may be computed as

η′=W/2·P_{k=2.λ}_{₀}_{=2c}^{²}_{/W}(1−P_{FA)} (30)

where P_{k.λ}⁻¹(y) denotes the inverse of the non-central chi-square CDF with k degrees of freedom and non-centrality parameter λ₀, at a particular probability in P. Generating or computation algorithms for non-central chi-square CDF and inverse that are widely available in the literature and commercial software may be used, for example Matlab™.

Above, the FAR and PD of an LRT for the detection of OFDM signals has been derived. It has been shown that the LRT threshold can be set according to (30). It is remarkable however that the LRT is dependent on the received SNR (signal to noise ratio) as shown in (16). In the case of detection for strong signals where SNR is large, the term 1/SNR in (16) may be neglected. In embodiments, however, where there are weak signals and/or the uncertain SNR due to changing noise power or interference the optimal LRT based OFDM detection as derived above may be ineffective. Therefore, in one embodiment, tests together with the threshold setting independent of the SNR are used. Nevertheless, the performance of LRT detection may serve as a performance bound for other suboptimal tests.

In the following, a suboptimal test that is robust to unknown noise/interference and that is used in one embodiment is described.

Before giving the proposed test statistic, the means and variances with respect to the SNR under the hypotheses Hₒ and H₁ are examined. From (5) and (6) it can be seen that the mean and variance of ζ under hypotheses H₀ are independent of the SNR as this is the signal-free case (i.e. no data-signal is present) and the noise has been normalized as in (4). As to ζ under hypotheses H₁, the mean and variance are functions of the SNR as shown in (8) and (9). They are in fact monotone functions and increase with SNR. The limits of the means and variances are given by

$$\begin{matrix}{m}_{1} = \{ \begin{matrix}0 & SNR \to - ∞ \\ α W & SNR \to + ∞\end{matrix} & ( 31 ) \\ {σ}_{1}^{2} = \{ \begin{matrix}W & SNR \to - ∞ \\ W ( 1 + 2 {α}^{2} ) & SNR \to + ∞\end{matrix} & ( 32 )\end{matrix}$$

It can be seen from (31) and (32) that 0≦m₁≦αW and W≦σ₁²≦W(1+2α²). As defined in the context of (8) and (9), α is no greater than 0.2 or α≦0.2 in an OFDM system according to one embodiment. Therefore, in one embodiment, the variance under hypothesis H₁ varies narrowly within W≦σ₁²≦1.08W, as opposed to the wide range of mean variation 0≦m₁≦0.2W. Based on this observation, it may be assumed that the variance is σ₁²≈W=σ₀² which greatly simplifies the test statistics. The LLR according to (11) can then be approximated by

$$\begin{matrix}\tilde{Λ} = ln \frac{\frac{1}{\sqrt{2 π} {σ}_{0}} exp ( - \frac{( ζ - {m}_{1} ) {( ζ - {m}_{1} )}^{H}}{2 {σ}_{0}^{2}} )}{\frac{1}{\sqrt{2 π} {σ}_{0}} exp ( - \frac{{ζζ}^{H}}{2 {σ}_{0}^{2}} )} \\ = \frac{{ζζ}^{H} - ( ζ - {m}_{1} ) {( ζ - {m}_{1} )}^{H}}{2 {σ}_{0}^{2}}\end{matrix} \qquad ( 33 )$$

After mathematical manipulations, the approximated LRT becomes

$$f ( \tilde{Λ} ) = Re ( ζ ) {}_{{<}_{{H}_{0}}}^{{{H}_{1}}_{>}}{m}{}_{1}^{} + \frac{{σ}_{0}^{2}}{{m}_{1}} ln η \qquad ( 34 )$$

where Re(.) stands for taking real part operation. From (34) it may be seen that the test statistic Re(λ) can be calculated solely through the sampled signal without prior knowledge of the SNR. In the following, its theoretical FAR to be used for threshold setting is derived based on the Neyman-Pearson Criterion.

Since the distribution of ζ is Gaussian under either hypothesis H₀ or H₁, it can be shown that the distribution of Re(ζ) is still Gaussian. With the approximation of σ₁²≈W=σ₀², Re(ζ) has a variance of c4/2 and means zero and m₁ as in (8), under hypotheses H₀ and H₁ respectively. Therefore the FAR of Re(ζ) can be written as

$$\begin{matrix}{\tilde{P}}_{FA} = P ( Re ( ζ ) > {η}^{″} \vert {H}_{0} ) \\ = {\int }_{{η}^{″}}^{∞} \frac{1}{\sqrt{π} {σ}_{0}} {e}^{- {t}^{2} / {σ}_{0}^{2}} d t \\ = \frac{1}{2} erfc ( \sqrt{2} \cdot {η}^{″} / \sqrt{W} )\end{matrix} \qquad ( 35 )$$

where the complementary error function is defined as

$$erfc ( x ) = \frac{2}{\sqrt{π}} {\int }_{x}^{∞} {e}^{- {t}^{2}} d t .$$

Based on the Neyman-Pearson Criterion, the threshold of the η″ can be calculated for any given \tilde{P}_{FA} using (35) as

η″=\sqrt{W}·erfc⁻¹) (2\tilde{P}_{FA}) (36)

From (36) it can be seen that the threshold setting is only related to the given FAR and observation window size. It is independent of SNR and insensitive to the uncertain noise or interference.

The theoretical PD of the suboptimal LRT can be obtained as

$$\begin{matrix}{\tilde{P}}_{D} = P ( Re ( ζ ) > {η}^{″} \vert {H}_{1} ) \\ = {\int }_{{η}^{″}}^{∞} \frac{1}{\sqrt{π} {σ}_{0}} {e}^{- {( t - {m}_{1} )}^{2} / {σ}_{0}^{2}} d t \\ = \frac{1}{2} erfc [ ( {η}^{″} - {m}_{1} ) / \sqrt{W} ] .\end{matrix} \qquad ( 37 )$$

In the following, results of simulations are shown to illustrate the performance of the proposed detection for OFDM signals under frequency selective fading channels. In the simulations, an OFDM based WiMax system is considered which is of a major concern for a UWB system implementing DAA. The system bandwidth (BW) of the WiMax considered is 7 MHz and the sampling rate is floor(n*BW/8000)*8000=8 MHz with n=8/7. The FFT size is 256 and the CP is ¼ of an OFDM symbol corresponding to receivers being far from the transmitter. The wireless channels are assumed to be slow Rayleigh fading channels with frequency selectivity. The multipath delay profile is assumed to be exponential.

Throughout the simulations, the detection time is assumed to be 10-millisecond long which is corresponding to the duration slightly over 300 OFDM symbols or a window size W=80000 samples.

A first set of simulations is to evaluate the distribution of the decision statistics

$$f ( Λ ) / \frac{{σ}_{ζ}^{2}}{2} = {\vert ζ + c \vert}^{2} / \frac{{σ}_{ζ}^{2}}{2}$$

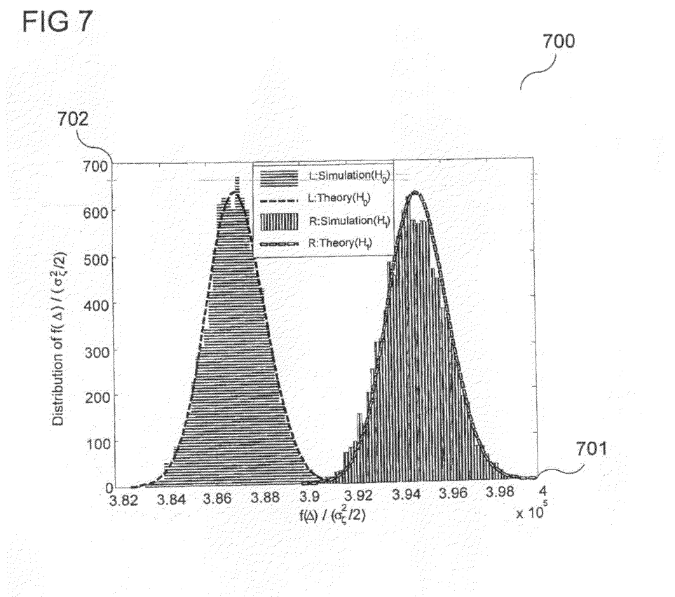

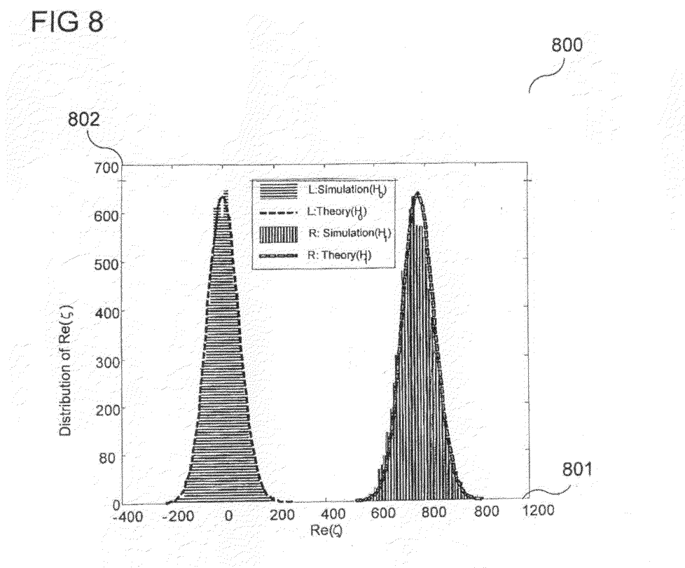

derived above for the LRT according to (13) (“optimal LRT”) under both hypotheses H₀ and H₁. For each run of simulations under hypotheses H₀, noise-only samples are used to calculate the value of the decision statistic. Based on 10000 runs of simulations, a histogram for the decision statistic has been generated. As to the simulations under the hypothesis H₁, a signal with SNR=0 dB is added to calculate the value of the decision statistic. Similarly, a histogram can also be generated with another 10000 runs of simulations. The two histograms are shown in FIG. 7 and FIG. 8.

In FIG. 7, in the direction of a first axis (x-axis) 701, values of

$$f ( Λ ) / \frac{{σ}_{ζ}^{2}}{2}$$

are indicated and, in the direction of a second axis (y-axis) 702, the corresponding values of the histogram and of the theoretical cumulative distribution function are shown for the hypotheses H₀ (left curve and bars; noise-only case) and H₁ (right curve and bars; signal plus noise case).

The two dashed curves have been generated based on the CDF of the theoretical non-central chi-square distribution as in (26) and (27) for the two hypotheses, respectively. It can be seen that the two theoretical curves fit the simulated histograms nicely. It confirms the probability distribution of the optimal LRT derived in above.

In FIG. 8, similarly, in the direction of a first axis (x-axis) 801, values of Re(ζ) are indicated and, in the direction of a second axis (y-axis) 802, the corresponding values of the histogram and of the theoretical cumulative distribution function are shown for the hypotheses H₀ (left curve and bars; noise-only case) and H₁ (right curve and bars; signal plus noise case).

This shows the distribution of the decision statistics f(Λ′)=Re(Λ) proposed above for the suboptimal test under both hypotheses H₀ and'H₁. The histograms may be generated as explained above. The two theoretical dashed curves are generated based on the CDF of the theoretical Gaussian distribution Re(α) with a variance of σ₀²/2 and means zero and mᵢ as in (8), under hypotheses H₀ and H₁, respectively. As can be seen from FIG. 8, the two theoretical curves fit the simulated histograms very well. It also verifies that the Gaussian distribution is a good approximation to the distribution of Re(ζ), the suboptimal test under both hypotheses H₀ and H₁.

Further, the threshold setting performance using the derived formulas for LRT and the proposed test is evaluated. According to Neyman-Pearson Criterion, a threshold may be set according to a given FAR. As an example, a 10% FAR which is the typical value quoted in IEEE 802.22 cognitive radio systems and a more stringent 1% FAR are used as examples.

Under hypothesis H₀ (absence of the signal) 10000 simulations have been run to calculate the decision statistics

$$f ( Λ ) / \frac{{σ}_{ζ}^{2}}{2} = {\vert ζ + c \vert}^{2} / \frac{{σ}_{ζ}^{2}}{2}$$

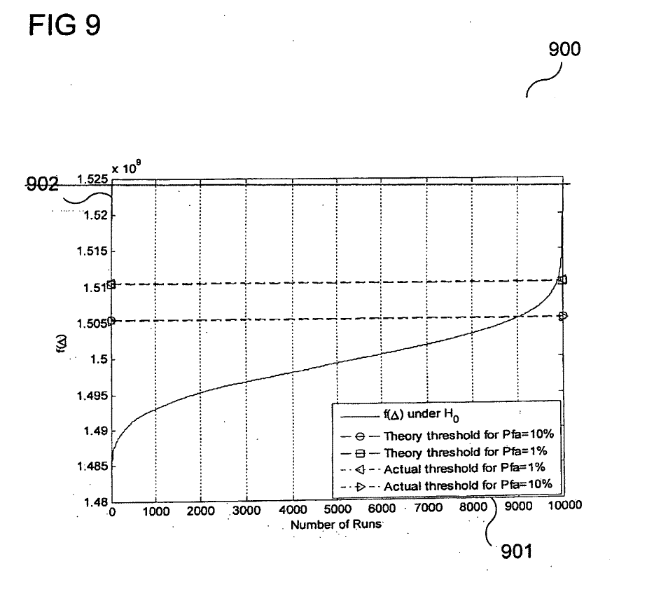

and f(Λ′)=Re(ζ) for LRT and the proposed test respectively. The results for LRT are shown in FIG. 9 where the values (indicated along the y-axis 902) of the decision statistics f(Λ) have been sorted in ascending order (from left to right along the x-axis 901) and form the solid curve. A FAR 10% means that 10% of the points (1000 out of 10000) of the solid curve have f(Λ) values greater than a threshold. Based on the curve presented, the threshold hitting the 9000^{th} point (or corresponding to FAR 10%) is depicted by the dash-dotted line with right-pointed triangle markers. Similarly, the threshold for 1% FAR (corresponding to the 9900^{th} point) is depicted by the dash-dotted line with left-pointed triangle markers. The other two dashed curves in FIG. 9 with circle and square marks are representing the theoretical thresholds for FAR 10% and FAR 1% respectively. They are calculated according to (30) where c², as shown in (16) is obtained with known SNR. The theoretical thresholds overlapping with the thresholds generated through simulations in FIG. 9 reveals that threshold setting through (16) is reliable with knowledge of SNR. It is noted that employing the theoretical thresholds in the simulations will give actual FAR 9.73% and 1.05%, corresponding to nominal FAR 10% and 1% respectively.

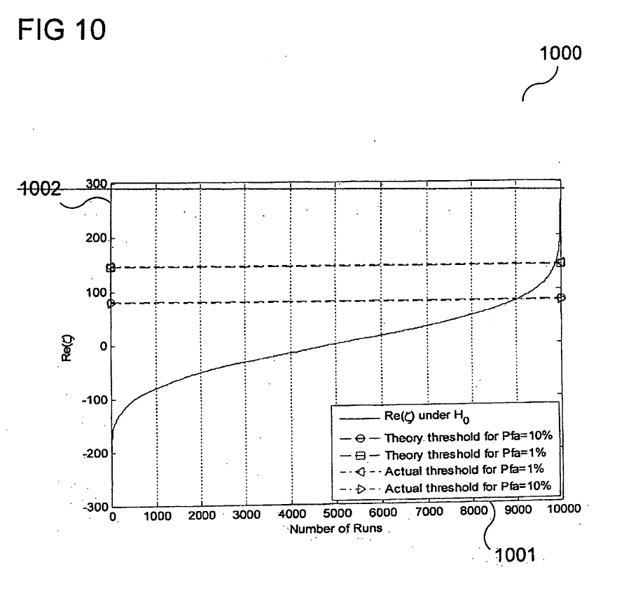

FIG. 10 shows the threshold setting performance for the test described above based on both the theoretical derivation (36) and simulations. Except for the different decision statistics f(Λ)=Re(ζ) (the values of which are ascending along the x-axis 1001 and are indicated along the y-axis 1002), all other conditions/parameters/notations are the same as for FIG. 9. It can be seen that the theoretical thresholds match nicely with the thresholds generated through simulations. Similar to simulations in FIG. 9, the theoretical thresholds in the simulations will give rise to the actual FAR 9.73% and 1.05%, corresponding to nominal FAR 10% and 1% respectively. It is notable that calculating the theoretical thresholds through (36) for the proposed test does not rely on SNR values. This makes the threshold setting robust to noise uncertainty.

Lastly, -the detection performance of the suboptimal test described above is determined. Before looking at the noise uncertainty issue, the performance difference of the proposed test as opposed to the optimal LRT is considered.

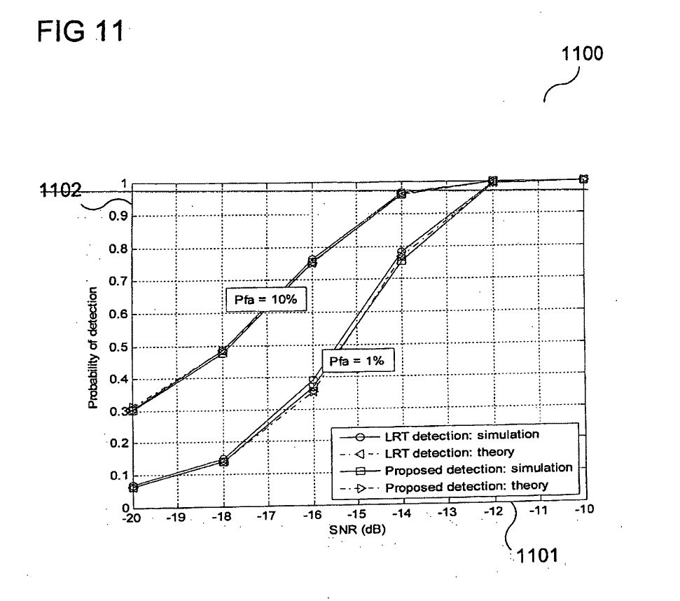

FIG. 11 shows the probability of detection performance (along y-axis 1102) versus SNR (along x-axis 1101) for the proposed detection and the benchmark LRT detection. At each SNR level, 10000 runs of simulations have been performed. The decision statistics

$$f ( Λ ) / \frac{{σ}_{ζ}^{2}}{2} = {\vert ζ + c \vert}^{2} / \frac{{σ}_{ζ}^{2}}{2}$$

and f(Λ′)=Re(ζ) have been calculated for LRT and the proposed detection respectively.

For a given FAR, i.e. 10% or 1% in this example, the corresponding thresholds are set according to (30) and (36) for LRT and the proposed detection respectively. The simulated probability of detection for each method, LRT or the proposed, and each given FAR, is the ratio of the number of runs with statistic values higher than the threshold over the total number of runs. Whereas the theoretical detection probabilities LRT and the proposed test can be computed directly from formulas (29) and (37), respectively. As shown in FIG. 11, the performance curves are clustering in two groups for FAR 10% and FAR 1%, respectively. Within each cluster, there are four curves representing LRT detection with the simulated PD (the solid line with circle markers), LRT detection with the theoretical PD (the dashed line with left-pointed triangle markers), the proposed detection with the simulated PD (the solid line with square markers), and the proposed detection with the theoretical PD (the dashed line with right-pointed triangle markers) respectively. It can be seen that the performance degradation from the proposed detection to the LRT detection is small in both cases of 10% FAR and 1% FAR. It should be noted that the LRT detection requires the knowledge of SNR to achieve the performance whereas the proposed detection does not need the additional information. It can also be found that all the theoretical curves match well with their corresponding simulated curves.

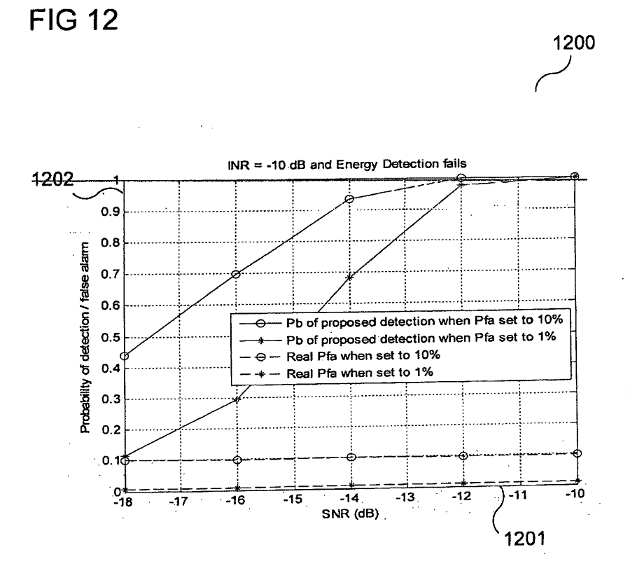

FIG. 12 shows the detection performance of the proposed test under interference or noise uncertainty. In the simulations, it is assumed that there exists weak interference with strength of 10 dB below the thermal noise floor at the time of the detection. The source of the interference could be an electrical fan or air conditioner switching on or other operating electronic devices in the vicinity. The performance has been simulated for both 10% FAR and 1% FAR with the thresholds set according to (36). It can be seen that the proposed detection can achieve very high detection probability (indicated along the y-axis 1202) of nearly 100% at the presence of the interference for SNR (indicated along x-axis 1201) as low as −12 dB and −10 dB SNR for 10% and 1% FAR respectively. The exact FARs (indicated along the y-axis 1202) represented by the dashed lines are also shown in FIG. 12. They are very close to 10% and 1% FARs as set.

Energy detection for the same scenarios fails to work with actual FAR 100%. The reason is that the energy detection treats the interference as a signal and thus always decides that a signal is present. In a cognitive radio system, especially for the UWB DAA system, it is important to know whether a signal/interference is from the incumbents or not. Only in case that there are signals from the incumbents such as WiMax (OFDM) signals, UWB devices need to lower down their transmission power or even shut down their transmissions.

In the following, the derivation of the mean and the variance of ζ under hypothesis H₁ is given.

Mean of ζ under hypothesis H₁:

With reference to (4), the mean of ζ under hypothesis H₁ is

$${m}_{1} {Δ}_{\underline{\_}} E [ ζ \vert {H}_{1} ] = E [ \frac{1}{W} \cdot {\sum }_{d} {z}_{d} ] = E [ {z}_{d} ] = E [ {r}_{d} \cdot {r}_{M + d}^{*} ] \qquad ( 38 )$$

Substituting (2) in (38) and using that the signal and noise are uncorrelated, one obtains

$$\begin{matrix}{m}_{1} = E [ {\hat{r}}_{d} \cdot {\hat{r}}_{M + d}^{*} ] \\ = E [ ( {\sum }_{i = 0}^{L - 1} {x}_{d - i} \cdot {h}_{i} ) \cdot ( {\sum }_{j = 0}^{L - 1} {x}_{M + d - j}^{*} \cdot {h}_{j}^{*} ) ] \\ = {\sum }_{i = 0}^{L - 1} {\sum }_{j = 0}^{L - 1} ( {h}_{i} \cdot {h}_{j}^{*} ) E [ {x}_{d - i} \cdot {x}_{M + d - j}^{*} ]\end{matrix} \qquad ( 39 )$$

A typical OFDM system used in one embodiment has a cyclic prefix duration longer than the effective channel length, i.e., L<K. Since K is only a fraction of M, it is reasonable to assume that L<M in the context of signal detection. This assumption implies the sets {x_{d-1}} (i=0 . . . L−1) and {_{M+d-j}} (j=0 . . . L−1) are disjoint. For i≠j, this translates to

E[x_{d-i}·\dot{x}_{M+d-j}]=E[x_{\dot{d}-i}·E[x_{\dot{M}+d-j}]=0 (40)

Applying (39) to (40), one obtains

$${m}_{1} = E [ {\hat{r}}_{d} \cdot {\hat{r}}_{M + d}^{*} ] = {\sum }_{i = 0}^{L - 1} {\vert {h}_{i} \vert}^{2} E [ {x}_{d - i} \cdot {x}_{M + d - i}^{*} ] \qquad ( 41 )$$

Since

x_{d-1}=x_{M+d-1} (42)

for x_{d-i} falling into cyclic prefix period and

E[x_{d-i}·x_{\dot{M}+d-i}]=E[x₋ᵢ]·E[x_{\dot{M}+d-i} =0 (43)

for x_{d-i} being outside of cyclic prefix period, (41) can be simplified to

$$\begin{matrix}{m}_{1} = P ( {x}_{d - i} ∈ CP ) \cdot {\sum }_{i = 0}^{L - 1} {\vert {h}_{i} \vert}^{2} E [ {\vert {x}_{d - i} \vert}^{2} ] \\ = K / ( M + K ) \cdot {\sum }_{i = 0}^{L - 1} {\vert {h}_{i} \vert}^{2} \cdot {σ}_{s}^{2} \\ = α \cdot {σ}_{\hat{r}}^{2}\end{matrix} \qquad ( 44 )$$

where P(·) and CP stand for the probability function and cyclic prefix part of the signal respectively. In the last equation, the channel path loss is absorbed in the received signal power.

Variance of ζ under hypothesis H₁:

Before computing the variance of

$$ζ = \frac{1}{W} {\sum }_{d} {z}_{d}$$

under hypothesis H₁, i.e. σ₁²ΔE[|ζ|²|H₁]−m₁², some preliminary results are given used in the subsequent derivation. Some of these results are

$$\begin{matrix}E [ {r}_{d} ] = E [ {\hat{r}}_{d} + {n}_{d} ] = E [ {\hat{r}}_{d} ] = E [ {\sum }_{i = 0}^{L - 1} {x}_{d - i} \cdot {h}_{i} ] = 0 & ( 45 ) \\ \begin{matrix}E [ {\vert {r}_{d} \vert}^{2} ] = E [ ( {\hat{r}}_{d} + {n}_{d} ) ( {\hat{r}}_{d}^{*} + {n}_{d}^{*} ) ] \\ = E [ {\vert {\hat{r}}_{d} \vert}^{2} ] + E [ {\vert {n}_{d} \vert}^{2} ] \\ = {σ}_{\hat{r}}^{2} + {σ}_{n}^{2}\end{matrix} & ( 46 ) \\ E [ {\hat{r}}_{d}^{*} \cdot {\hat{r}}_{M + d} ] = {E [ {\hat{r}}_{d} \cdot {\hat{r}}_{M + d}^{*} ]}^{*} = {m}_{1}^{*} = α \cdot {σ}_{\hat{r}}^{2} & ( 47 )\end{matrix}$$

where the equalities in (47) follow directly from (39) and (44).

The next result that is used is

$$\begin{matrix}E [ {\hat{r}}_{d} \cdot {\hat{r}}_{M + d} ] = E [ ( {\sum }_{i = 0}^{L - 1} {x}_{d - i} \cdot {h}_{i} ) \cdot ( {\sum }_{j = 0}^{L - 1} {x}_{M + d - j} \cdot {h}_{j} ) ] \\ = {\sum }_{i = 0}^{L - 1} {\sum }_{j = 0}^{L - 1} ( {h}_{i} \cdot {h}_{j} ) E [ {x}_{d - i} \cdot {x}_{M + d - j} ] \\ = {\sum }_{i = 0}^{L - 1} {\vert {h}_{i} \vert}^{2} E [ {x}_{d - i} \cdot {x}_{M + d - i} ] \\ = P ( {x}_{d - i} ∈ CP ) \cdot {\sum }_{i = 0}^{L - 1} {\vert {h}_{i} \vert}^{2} E [ {x}_{d - i} \cdot {x}_{M + d - i} ] \\ = 0\end{matrix} \qquad ( 48 )$$

The last equation in (48) holds since E[x_{d-i}·x_{d-i}]=0 for any complex Gaussian variable x_{d-i} under circularity assumption.

The final preliminary result used is the second moment of z_{d}=r·r_{\dot{M}+d}, i.e.,

$$\begin{matrix}E [ {\vert {z}_{d} \vert}^{2} ] = E [ ( {r}_{d} \cdot {r}_{M + d}^{*} ) ( {r}_{d}^{*} - {r}_{M + d} ) ] \\ = E [ ( {\hat{r}}_{d} + {n}_{d} ) ( {\hat{r}}_{M + d}^{*} + {n}_{M + D}^{*} ) ( {\hat{r}}_{d}^{*} + {n}_{d}^{*} ) ( {\hat{r}}_{M + d} + {n}_{M + d} ) ] \\ = E [ \begin{matrix}( {\vert {\hat{r}}_{d} \vert}^{2} + {\vert {n}_{d} \vert}^{2} + {\hat{r}}_{d} \cdot {n}_{d}^{*} + {n}_{d} \cdot {\hat{r}}_{d}^{*} ) \cdot \\ ( \begin{matrix}{\vert {\hat{r}}_{M + d} \vert}^{2} + {\vert {n}_{M + d} \vert}^{2} + {\hat{r}}_{M + D} \cdot \\ {n}_{M + D}^{*} + {n}_{M + d} \cdot {\hat{r}}_{M + d}^{*}\end{matrix} )\end{matrix} ]\end{matrix} \qquad ( 49 )$$

Removing obvious zero noise items, the formula (49) can be simplified as

$$\begin{matrix}E [ {\vert {z}_{d} \vert}^{2} ] = E [ ( {\vert {\hat{r}}_{d} \vert}^{2} + {\vert {n}_{d} \vert}^{2} ) ( {\vert {\hat{r}}_{M + d} \vert}^{2} + {\vert {n}_{M + d} \vert}^{2} ) ] \\ = E ( {\vert {\hat{r}}_{d} \vert}^{2} \cdot {\vert {\hat{r}}_{M + d} \vert}^{2} ) + E ( {\vert {\hat{r}}_{d} \vert}^{2} \cdot {\vert {n}_{M + d} \vert}^{2} ) + \\ E ( {\vert {n}_{d} \vert}^{2} \cdot {\vert {\hat{r}}_{M + d} \vert}^{2} ) + E ( {\vert {n}_{d} \vert}^{2} \cdot {\vert {n}_{M + d} \vert}^{2} )\end{matrix} \qquad ( 50 )$$

Since \hat{r}_{d} and n_{d} are complex Gaussian distributed, the formula (51) below may be used to compute the fourth order moments in the above equation, which is valid for complex random variables as well:

E[y₁y₂y₃y₄]=E(y₁y₂)·E(y₃y₄)+E(y₁y₃)·E(y₂y₄)+E(y₁y₄)·E(y₂y₃)−2E(y₁)·E(y₂)·E(y₃)·E(y₄) (51)

Using E[\hat{r}_{d}]=E[\hat{r}_{M+d}]=E[\hat{r}_{\dot{d}}]=E[\hat{r}r_{M+d}4]=0 and applying (51), the first item in (50) may be developed as

E(|\hat{r}_{d}|²·|\hat{r}_{M+d}|²)=E(|\hat{r}_{d}|²)·E(|\hat{r}_{M+d}|²)+E(\hat{r}_{d}·\hat{r}_{M+d})·E(\hat{r}_{d}·\hat{r}_{\dot{M}+d}+E(\hat{r}·\hat{r}_{\dot{M}+d})·E(\hat{r}_{\dot{d}}·\hat{r}_{M+d}) (52)

Substitute (44) and (46)-(48) in (52), one has

E(|\hat{r}_{d}|²·|\hat{r}_{M+d}|²)=σ_{\hat{r}}²·σ_{\hat{r}}²+α·σ_{\hat{r}}²·α·σ_{\hat{r}}²=(1+α²)·σ_{\hat{r}}⁴ (53

Since the received signal is uncorrelated with the AWGN noise n_{d}, the second to fourth items in (50) may be obtained as

E(|\hat{r}_{d}|hu 2·n_{M+d}|²)=E(|\hat{r}_{d}|²)·E(|n_{M+d}|²)=σ_{\hat{r}}²σₙ² (54)

E(|n_{d}|²·|\hat{r}_{M+d}|²)=E(|\hat{r}_{M+d}|²)·E(|n_{d}|²)=σ_{\hat{r}}²σₙ² (55)

E(|n_{d}|²·|n_{M+d}|²)]=E(|n_{d}|²)·E(|n_{M+d}|²)=σₙ⁴ (56)

With all the results from (53) to (56) being substituted in (50), one arrives at

E[|z_{d}|²]=[1+α²]σ_{\hat{r}}⁴+2σ_{\hat{r}}²σₙ²+σₙ⁴=m₁²+(σ_{\hat{r}}²+σₙ²)². (57)

With (57) at hand, the variance of ζ under hypothesis H₁ may be derived. According to the definition of ζ as in (4), one has

$$\begin{matrix}E [ {\vert ζ \vert}^{2} ] = \frac{1}{{W}^{2}} E [ {\sum }_{d} {z}_{d} \cdot {\sum }_{d} {z}_{d}^{*} ] \\ = \frac{1}{{W}^{2}} {\sum }_{{d}_{1}} {\sum }_{{d}_{2}} E [ {z}_{{d}_{1}} \cdot {z}_{{d}_{2}}^{*} ] \\ = \frac{1}{{W}^{2}} {\sum }_{{d}_{1}} {\sum }_{{d}_{2}} E [ \begin{matrix}( {\hat{r}}_{{d}_{1}} + {n}_{{d}_{1}} ) ( {\hat{r}}_{M + {d}_{1}}^{*} + {n}_{M + {d}_{1}}^{*} ) \cdot \\ ( {\hat{r}}_{{d}_{2}}^{*} + {n}_{{d}_{2}}^{*} ) ( {\hat{r}}_{M + {d}_{2}} + {n}_{M + {d}_{2}} )\end{matrix} ] \\ = \frac{1}{{W}^{2}} {\sum }_{{d}_{1}} {\sum }_{{d}_{2}} {}_{( {d}_{1} \neq {d}_{2} )} E [ \begin{matrix}( {\hat{r}}_{{d}_{1}} + {n}_{{d}_{1}} ) ( {\hat{r}}_{M + {d}_{1}}^{*} + {n}_{M + {d}_{1}}^{*} ) \cdot \\ ( {\hat{r}}_{{d}_{2}}^{*} + {n}_{{d}_{2}}^{*} ) ( {\hat{r}}_{M + {d}_{2}} + {n}_{M + {d}_{2}} )\end{matrix} ] + \\ \frac{1}{W} E [ {\vert {z}_{d} \vert}^{2} ]\end{matrix} \qquad ( 58 )$$

Removing zero items due to uncorrelated noises in (58), equation (58) can be simplified as

$$E [ {\vert ζ \vert}^{2} ] = \frac{1}{{W}^{2}} {\sum }_{{d}_{1}} {\sum }_{{d}_{2}} {}_{( {d}_{1} \neq {d}_{2} )} E [ {\hat{r}}_{{d}_{1}} \cdot {\hat{r}}_{M + {d}_{1}}^{*} \cdot {\hat{r}}_{{d}_{2}}^{*} \cdot {\hat{r}}_{M + {d}_{2}} ] + \frac{1}{W} E [ {\vert {z}_{d} \vert}^{2} ] \qquad ( 59 )$$

Applying formula (51) to (59) and substituting (45), one has

$$E [ {\vert ζ \vert}^{2} ] = \frac{1}{{W}^{2}} {\sum }_{{d}_{1}} {\sum }_{{d}_{2}} {}_{( {d}_{1} \neq {d}_{2} )} \{ E [ {\hat{r}}_{{d}_{1}} \cdot {\hat{r}}_{M + {d}_{1}}^{*} ] \cdot E [ {\hat{r}}_{{d}_{2}}^{*} \cdot {\hat{r}}_{M + {d}_{2}} ] + E [ {\hat{r}}_{{d}_{1}} \cdot {\hat{r}}_{{d}_{2}}^{*} ] \cdot E [ {\hat{r}}_{M + {d}_{1}}^{*} \cdot {\hat{r}}_{M + {d}_{2}} ] + E [ {\hat{r}}_{{d}_{1}} \cdot {\hat{r}}_{M + {d}_{2}} ] \cdot E [ {\hat{r}}_{M + {d}_{1}}^{*} \cdot {\hat{r}}_{{d}_{2}}^{*} ] \} + \frac{1}{W} E [ {\vert {z}_{d} \vert}^{2} ] \qquad ( 60 )$$

It may be seen that the second term within the brace of (60) is non-zero only when d₁=M+d₂ or d₂=M+d₁. The third term is zero since E[\hat{r}_{d}·\hat{r}_{d}]=0 and E[\hat{r}_{d}=0. Therefore, substituting (39), (8), and (57) in (60), gives

$$\begin{matrix}E [ {\vert ζ \vert}^{2} ] = \frac{1}{{W}^{2}} {\sum }_{{d}_{1}} {\sum }_{{d}_{2}} {}_{( {d}_{1} \neq {d}_{2} )}^{}{m}{}_{1}^{2} + \\ \frac{1}{{W}^{2}} {\sum }_{{d}_{1}} {\sum }_{{d}_{2}} {}_{( \begin{matrix}{d}_{1} \neq M + {d}_{2} or \\ {d}_{2} = M + {d}_{1}\end{matrix} )}^{}{m}{}_{1}^{2} + \frac{1}{W} [ {m}_{1}^{2} + {( {σ}_{\hat{r}}^{2} + {σ}_{n}^{2} )}^{2} ] \\ = ( 1 + \frac{1}{W} ) {m}_{1}^{2} + \frac{1}{W} [ {m}_{1}^{2} + {( {σ}_{\hat{r}}^{2} + {σ}_{n}^{2} )}^{2} ] \\ = ( 1 + \frac{2}{W} ) {m}_{1}^{2} + \frac{1}{W} {( {σ}_{\hat{r}}^{2} + {σ}_{n}^{2} )}^{2}\end{matrix} \qquad ( 61 )$$

Finally, the variance of ζ is obtained as in (9).

What follows is a proof of Preposition 1.

The characteristic function of the non-central chi-square distributed random variable r₁(i=1KN) is

$${ϕ}_{i} ( t ) = \frac{{e}^{\frac{{jλ}_{i} t}{1 - 2 j t}}}{{( 1 - 2 j t )}^{{k}_{i} / 2} } \qquad ( 62 )$$

Since rᵢ(i=1KN) are independent from each other, the characteristic function of

$${\sum }_{i = 1}^{N} {r}_{i}$$

is

$$\begin{matrix}{ϕ}_{Σ} ( t ) = {\prod }_{i = 1}^{N} {ϕ}_{i} ( t ) \\ = \frac{{\prod }_{i = 1}^{N} {e}^{\frac{{jλ}_{i} t}{1 - 2 j t}}}{{\prod }_{i = 1}^{N} {( 1 - 2 j t )}^{{k}_{i} / 2}} \\ = \frac{{e}^{\frac{j ( {\sum }_{i = 1}^{N} {λ}_{i} ) t}{1 - 2 j t}}}{{( 1 - 2 j t )}^{( {\sum }_{i = 1}^{N} {k}_{i} ) / 2}} \\ = \frac{{e}^{\frac{{jλ}^{′} t}{1 - 2 j t}}}{{( 1 - 2 j t )}^{{k}^{′} / 2}}\end{matrix} \qquad ( 63 )$$

where

$${λ}^{′} = {\sum }_{i = 1}^{N} {λ}_{i} and {k}^{′} = {\sum }_{i = 1}^{N} {k}_{i} ,$$

and the proposition follows.

1. A method for determining whether a transmission signal comprising a cyclic prefix is present in a received signal, the method comprising:
determining a plurality of received signal values from the received signal;
forming a plurality of different pairs of the received signal values based on a predefined periodicity of the cyclic prefix;
determining a correlation term value for each of the plurality of pairs of the received signal values, wherein the correlation term value for a pair is determined based on a multiplication of one of the received signal values of the pair with the complex conjugate of the other of the received signal values of the pair; and
determining whether a transmission signal is present in the received signal based on a combination of the correlation term values, wherein the combination of the correlation term values takes into account an expected value of a measure of at least one of the received signal values affected by noise.

2. The method according to claim 1, wherein the transmission signal comprises a plurality of transmission symbols, wherein each transmission symbol comprises a useful transmission symbol prepended with a cyclic prefix.

3. The method according to claim 2, wherein each useful transmission symbol corresponds to a plurality of data symbols.

4. The method according to claim 3, wherein the cyclic prefix of a transmission symbol corresponds to a part of the data symbols of the useful transmission symbol.

5. The method according to claim 4, wherein the cyclic prefix of a transmission symbol corresponds to a number of the last data symbols of the useful transmission symbol.

6. The method according to claim 3, wherein the predefined periodicity is the number of data symbols to which each useful transmission symbol corresponds.

7. The method according to claim 6, wherein each pair of received signal values is formed such that between one of the received signal values of the pair and the other of the received signal values of the pair there is a number of received signal values according to the periodicity.

8. The method according to claim 1, wherein the predefined periodicity is the transmission time of a useful transmission symbol.

9. The method according to claim 8, wherein each pair of received signal values is formed such that the transmission time of the received signal values of the pair differs by the predefined periodicity.

10. The method according to claim 1, wherein the transmission signal is an orthogonal frequency division multiplexing signal comprising a plurality of orthogonal frequency division multiplexing symbols, wherein each orthogonal frequency division symbol comprises a sequence of data symbols in the time domain and a cyclic prefix.

11. The method according to claim 1, wherein the combination of the correlation term values is based on a sum of the correlation term values.

12. The method according to claim 1, wherein the determination whether a transmission signal is present in the received signal comprises the calculation of a decision value from the combination of the correlation term values and wherein it is determined whether a transmission signal is present in the received signal based on whether the decision value is below or above a predefined threshold.

13. The method according to claim 1, wherein the expected value of a measure of at least one of the signal values is the expected value of a norm of one of the signal values affected by noise.

14. The method according to claim 1, wherein the noise is the noise that is expected to affect the data signal in course of the reception.

15. A circuit for determining whether a transmission signal comprising a cyclic prefix is present in a received signal, comprising:
a first determining circuit configure to determine a plurality of received signal values from the received signal;
a forming circuit configured to form a plurality of different pairs of the received signal values based on a predefined periodicity of the cyclic prefix;
a second determining circuit configured to determine a correlation term value for each of the plurality of pairs of the received signal values, wherein the correlation term value for a pair is determined based on a multiplication of one of the received signal values of the pair with the complex conjugate of the other of the received signal values of the pair; and
a third determining circuit configured to determine whether a transmission signal is present in the received signal based on a combination of the correlation term values, wherein the combination of the correlation term values takes into account an expected value of a measure of at least one of the received signal values affected by noise.

16. A processor configured to carry out a method for determining whether a transmission signal comprising a cyclic prefix is present in a received signal, the method comprising:
determining a plurality of received signal values from the received signal;
forming a plurality of different pairs of the received signal values based on a predefined periodicity of the cyclic prefix;
determining a correlation term value for each of the plurality of pairs of the received signal values, wherein the correlation term value for a pair is determined based on a multiplication of one of the received signal values of the pair with the complex conjugate of the other of the received signal values of the pair; and
determining whether a transmission signal is present in the received signal based on a combination of the correlation term values, wherein the combination of the correlation term values takes into account an expected value of a measure of at least one of the received signal values affected by noise.
